(19) United States
(12) Patent Application Publication
(10) Pub. No.: US 2003/0167409 A1
(43) Pub. Date: Sep. 4, 2003

(54) Secure electronic directory and catalog synchronization using email to trigger synchronization

(76) Inventor: Lester Sussman, Bethesda, MD (US)

Correspondence Address: LESTER SUSSMAN, 9213 BULLS RUN PARKWAY, BETHESDA, MD, 20817, US

(21) Appl. No.: 10/086,799

(22) Filed: Mar. 4, 2002

(51) Int. Cl. H04L 9/00

(52) U.S. Cl. 713/201

(57) ABSTRACT

This invention relates to the synchronization of electronic directories and catalogs located on a remote computer, or a remote electronic device and a central computer that maintains the master copies of the directories and catalogs. Email is used to notify a subscriber of changes to the subscribed master directories and, or catalogs. PKI cryptography is used to verify the email and the integrity of the directory and catalog updates. The remote computer uses information in the email to download the updates using the Internet. The updates are then applied to the local copy of the directory and, or catalog.

### BACKGROUND OF THE INVENTION

This invention relates to the synchronization of electronic directories and catalogs located on a remote computer, or remote electronic device and a central computer that contains the master copies of the directories and catalogs. The central computer keeps track of the changes made to the master copies. The central computer tracks which remote computer has subscribed to the synchronization service for a specific directory and, or catalog.

An electronic directory and catalog can simply be viewed as a file that contains a specific computer file layout structure with specific data.

The focus of this invention primarily uses the Internet as the communications network for the update process, but any network could be used, e.g. a company's private local area network or wide area network, etc.

Today the remote computer generally initiates computer file synchronization by accessing the central computer. Via a common protocol the remote and central computers discover whether or not the remote computer requires updates to its files. Examples of systems using this methodology include anti-virus applications that need periodic updates to their virus definitions file. Other examples include applications that download updates via the Internet. Generally the files on the remote computer contain a version number that is then compared with the files on the central computer. If the remote files do not have the same version number as the central files, then the remote computer downloads the necessary files.

Whilst the current methodologies have applicability to many applications, this invention offers another methodology that reduces the frequency that the remote and central computers need communicate with each other.

### OBJECTIVES AND SUMMARY OF THE INVENTION

The following are objectives of the current invention:

1. To provide a system and method in which a service provider maintains a master copy of a catalog/directory, that is distributed to subscribers who use a copy of the catalog/directory locally on an electronic device. The electronic device has embedded computer circuitry to process information.

2. To provide a method that reduces the frequency of interaction between the subscriber's electronic device and the service provider to query the availability of changes to the subscriber's catalog/directory.

3. To provide a secure and verifiable method of communicating catalog/directory update notifications from the service provider to the subscriber.

4. To provide a secure and verifiable method of downloading catalog/directory updates from the service provider to the subscriber.

5. To provide a method of receiving catalog/directory updates from the service provider to the subscriber such that the data integrity of the updates is maintained.

6. To provide a method of notifying the service provider on the success of applying updates by the subscriber.

### BRIEF DESCRIPTION OF THE DRAWINGS

FIG. 1 is a block diagram of the preferred embodiment illustrating the central service provider connected to the remote subscriber via the Internet.

### DETAILED DESCRIPTION OF THE INVENTION

Data integrity is critical in most information systems. For example if a phone directory contained incorrect data, the user could contact the wrong number. The Internet has many stories in which hackers accessed a computer and modified, inserted or deleted data. To reduce this risk, the current invention uses cryptography technology such as Secure Sockets Layer (SSL) and Public Key Infrastructure (PKI).

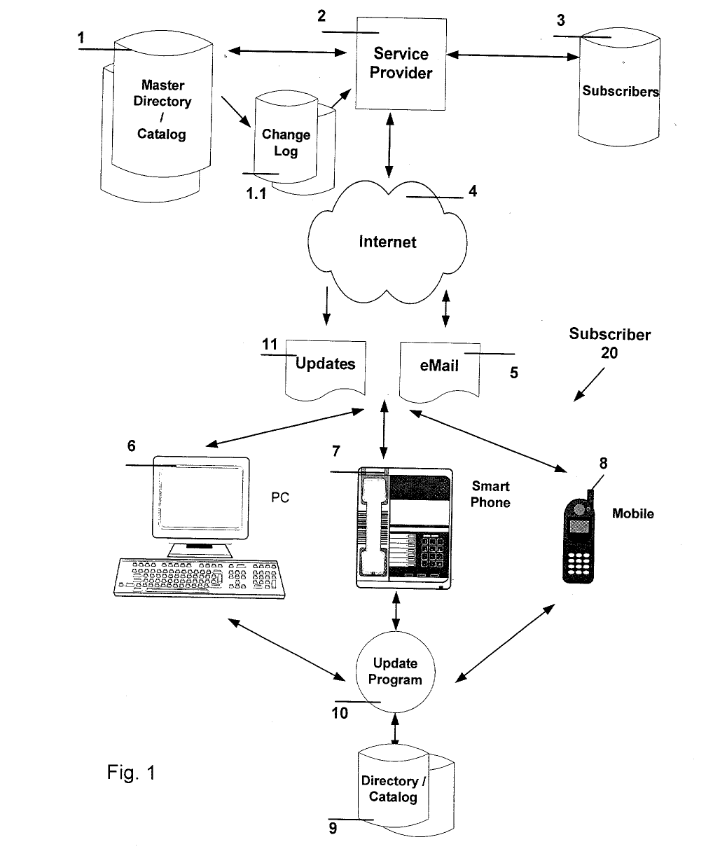

Before continuing with the detailed description of the preferred embodiment, an overview, with reference to FIG. 1, follows of various cryptography technologies that are used by the preferred embodiment.

Using cryptography technology such as SSL and PKI, secure communication between all participants, via the Internet 4 is used in this invention's preferred embodiment. Furthermore, information stored on the various participants' databases can be encrypted as well.

Cryptography for Verification, Integrity and Confidentiality

Two key technologies that the preferred embodiment of the invention uses is public key and conventional cryptography to ensure three things:

The transaction partner (e.g. directory subscriber 20, directory service provider 2, etc.) is who he claims to be.

Confidentiality of the data transmitted between the transaction partners.

The data has not been altered during storage and transmission.

Various implementations of cryptography are used in the invention's preferred embodiment, such as Netscape's Secure Socket Layer (SSL), Phil Zimmerman's Pretty Good Privacy (PGP), Microsoft's Secure Electronic Transactions (SET), OpenPGP (the IETF's RFC 2440) and other available PKI encryption standards. All of these methods use a combination of public key and conventional cryptography.

Conventional cryptography is also called secret key or symmetric key cryptography. The Data Encryption Standard (DES), Triple Des and Message Digest 5 (MD5) are examples of symmetric key cryptography. MD5 is described in further detail in the Internet Engineering Task Force's (IETF) RFC 1321. Use of secret keys to encrypt data is much faster than public key encryption, but the problem of using symmetric keys is the safe distribution of the keys between transaction partners. This key distribution is solved using public key cryptography.

Public key cryptography is an asymmetric method that uses a pair of keys for encryption: a public key that encrypts data and a private key (i.e. secret key) that decrypts the data. The public key is openly distributed. The key's owner keeps the private key secret. The secret key cannot readily be derived from the public key.

The above methods of cryptography are not described in detail in this invention. Excellent references are available that were used to devise the preferred embodiment of the invention. These references include:

“An Introduction to Cryptography” by Network Associates, Inc.

“How SSL Works” by Netscape.

“Internet Cryptography” by Richard E. Smith.

“Applied Cryptography” by Bruce Schneier.

The Internet Engineering Task Force RFC library.

A brief description follows of the various cryptography implementations that the invention's preferred embodiment uses.

PGP uses a combination of public-key and conventional encryption to provide security services for electronic-mail messages and data files. These services include confidentiality and digital signature. The IETF has a number of RFCs on PGP, which is also known as OpenPGP, e.g. RFC 1991 (“PGP Message Exchange Formats”) and RFC 2440 (“Open Message Format”).

Some background on PGP now follows. When plaintext is encrypted with PGP, PGP first compresses the plaintext. Data compression saves data transmission time and device memory space and, more importantly, strengthens cryptographic security. Most cryptanalysis techniques exploit patterns found in the plaintext to decode the cipher. Compression reduces these patterns in the plaintext, thereby greatly enhancing resistance to cryptanalysis. PGP then creates a session key, which is a one-time-only secret key. This key is a random number generated from the random movements, e.g. of a computer's mouse and the keystrokes that are typed. This session key works with a very secure, fast conventional encryption algorithm to encrypt the plaintext; the result is ciphertext. Once the data is encrypted, the session key is then encrypted to the recipient's public key. This public key-encrypted session key is transmitted along with the ciphertext to the recipient.

Decryption works in the reverse. The recipient's copy of PGP uses her private key to recover the temporary session key, which PGP then uses to decrypt the conventionally encrypted ciphertext.

The combination of the two encryption methods combines the convenience of public key encryption with the speed of conventional encryption. Conventional encryption is about a thousand times faster than public key encryption. Public key encryption in turn provides a solution to key distribution and data transmission issues. Used together, performance and key distributions are improved without any sacrifice in security.

A cryptographic key is a value that works with a cryptographic algorithm to produce a specific ciphertext. Keys are stored in encrypted form. PGP stores the keys in two files on the user's computing device (e.g. PC 6, SmartPhone 7, or Mobile device 8): one for public keys and one for private keys. These files are called keyrings.

The invention's preferred embodiment uses PGP to create digital certificates. Digital certificates (certificates) allow the recipient of information to verify the authenticity of the information's origin. In other words, digital certificates provide authentication and data integrity. Non-repudiation is also provided. A digital certificate consists of three components:

A public key,

Certificate information, e.g. email data contained in a Change Log notification (refer to Table 2 below).

One or more digital signatures.

The purpose of a digital signature on a certificate is to attest that the certificate information has been electronically notarized by some other person or entity, e.g. from a trusted third party such as a Certificate Authority (e.g. VeriSign). The digital signature does not validate the authenticity of the whole certificate; it only vouches that the signed identity information goes along with the public key. PGP uses a one-way hash function to create a digital signature. Valid hash functions used in the IETF's OpenPGP include MD2, MD5, SHA-I and RIPEMD-160. PGP uses a hash function on the certificate information that is being signed. This generates a fixed length data item known as a message digest. Any alteration to the certificate information results in a totally different message digest (digest), i.e. data integrity is established. PGP then uses the message digest and the private key to create the digital signature. Upon receipt of the certificate, the recipient uses PGP to re-compute the message digest, thus verifying the signature. As long as a secure hash function is used, there is no way to take someone's signature from one document and attach it to another, or to alter a signed message in any way. The slightest change in a signed document will cause the digital signature verification process to fail.

The preferred embodiment uses various trusted parties to create digital certificates. Various formats exist for digital certificates including PGP and the International Telecommunications Union's (ITU) X.509 certificates. The preferred embodiment of the invention uses PGP certificates, but could easily use X.509 certificates, or other certificate formats. The format of a PGP certificate is as follows:

The PGP version number—identifies which version of PGP was used to create the key associated with the certificate.

The certificate holder's public key—public portion of the holder's asymmetric key pair together with the algorithm of the key: RSA, Diffie-Hellman, or DSA.

The certificate holder's information—e.g. subscriber name, subscriber logon user ID, subscriber address, etc.

The digital signature of the certificate owner—uses the private key of the certificate holder's public key.

The certificate's validity period—start date and expiration date.

The preferred symmetric key method for the key—e.g. Triple-DES, CAST, or IDEA.

SSL has been universally accepted on the Internet 4 for authenticated and encrypted communication between clients and servers. It uses TCP/IP, and in the process allows an SSL-enabled server to authenticate itself to an SSL-enabled client, allows the client to authenticate itself to the server, and allows both machines to establish an encrypted connection. These capabilities address fundamental concerns about secure communication over the Internet 4 and other TCP/IP networks:

SSL server authentication allows a user to confirm a server's identity. SSL-enabled client software running on a computing device can use standard techniques of public-key cryptography to check that a server's certificate and public ID are valid and have been issued by a certificate authority (CA) listed in the client's list of trusted CAs. SSL client authentication allows a server (e.g. the Service Provider 2, etc.) to confirm a user's identity. Using the same techniques as those used for server authentication, SSL-enabled server software can check that a client's certificate and public ID are valid and have been issued by a certificate authority listed in the server's list of trusted CAs.

An encrypted SSL connection requires all information sent between a client and a server to be encrypted by the sending software and decrypted by the receiving software, thus providing a high degree of confidentiality. Confidentiality is important for both parties to any private transaction. In addition, all data sent over an encrypted SSL connection is protected with a mechanism for detecting tampering, that is for automatically determining whether the data has been altered in transit.

For more details on SSL, the Netscape web site provides a wealth of information at http://developer.netscape.com/docs/manuals/security.

TLS (Transport Layer Security) is a new and evolving Internet Engineering Task Force (IETF) standard and is based on SSL. TLS is defined in RFC 2818 (“HTTP Over TLS”). This invention does not exclude the use of TLS in place of SSL when TLS is adopted on the Internet 4.

Returning the detailed description of the preferred embodiment, with reference to FIG. 1, a Service Provider 2 maintains the master copy of directories, catalogs and databases 1 for a list of Subscribers 20, who are maintained in a subscriber database 3. An example of a directory that the Service Provider 2 maintains is the telephone book. An example of a catalog that is maintained could be the Sears mail order catalog. A phone directory and catalog are simply databases containing specific information.

The Subscribers 20 each has an electronic copy of the directories and catalogs 9 that they have subscribed to. In the description of the preferred embodiment, directories and catalogs are taken to be synonymous. For example, a telephone directory may simply be viewed as a catalog of phone numbers, businesses and people. The subscribers' catalog copy is stored in an electronic device such as a PC 6, a SmartPhone 7 or a Mobile 8 (wireless phone or PDA such as a Palm). Each of these electronic devices has computer memory and circuitry to store, retrieve, display and update information that is contained in the catalog 9. Any other device that has the appropriate electronics is included in the devices applicable to the current invention, e.g. game consoles such as the Sony Playstation, Microsoft's Xbox, TV set-top boxes such as Microsoft's UltimateTV and Philips TiVo, etc.

Updates 11 to the subscribers' catalogs are received via the Internet 4, or any other electronic network such as a company's private network (not shown in FIG. 1). Each of the subscriber's electronic devices is connected to the network. The specific connection could be via a network interface card, e.g. an Ethernet card, an analog modem or a broadband connection such as DSL, cable modem, 2.5G wireless, 3G wireless, etc. The preferred embodiment does not exclude other types of network connections that connect the subscriber's electronic device to the Service Provider 2. To simplify the description of the preferred embodiment network connection from the subscriber to the Service Provider 2 shall be considered in terms of the Internet 4. The preferred embodiment of the invention makes extensive use of the various Internet Protocols such as TCP/IP, DNS, POP, IMAP, SMTP, HTTP, FTP, etc.

The subscriber's electronic device must be able to receive, verify and display an electronic-mail (email 5) message sent by the Service Provider 2. Furthermore the subscriber's electronic device must be able to download catalog Updates 11, i.e. Change Logs 1.1 that the Service Provider 2 is holding for the Subscriber 20.

Service Provider Updates

Each of the master catalogs 1 that the Service Provider 2 maintains, i.e. add, delete and update entries in the master catalogs 1, has an associated list of Subscribers 20. This list is maintained in the Subscribers database 3. The Service Provider 2 stores other subscriber information in the database 3 as described in Table 1.

TABLE 1

| Subscriber Database Information | | Description |
|---|---|---|
| 1. | Name | Subscriber's last, middle and first |
| | | names |
| 2. | Address | Subscriber's billing, |
| | | or contact address |
| 3. | Telephone Number | Subscriber's contact |
| | | telephone number |
| 4. | Email | Subscriber's email address |
| | | to which |
| | | catalog updates are addressed |
| 5. | Digital Certificate | Subscriber's digital certificate, if |
| | | available |
| 6. | User ID | Subscriber logon user ID |
| | | to download |
| | | changes |
| 7. | Network Modem Type | Subscriber's internet modem type |
| 8. | ISP | Subscriber's Internet Service |
| | | Provider |
| 9. | Time Stamp of Last Update | Day and time of last email sent to |
| | Notification | subscriber |
| 10. | Time Stamp of Last Update | Day and time of subscriber's |
| | Completion | acknowledged update |
| 11. | List of Subscribed Directories/ | List of subscriber's catalogs and |
| | Catalogs (i.e. databases) | directories |

Whenever a change is made to a catalog, a Change Log 1.1 is created and stored at the Service Provider 2. The current invention simply stores a log of the various change records, e.g. record XYZ is deleted, record ABC phone number changed, etc. The current invention optimizes the Change Log size to minimize the time that a Subscriber will need to download the file. One method that the current invention uses is to compress the data. Many common computer file compression techniques are available such as PKZIP, gzip, compress, etc. Another way to optimize file size is to abbreviate data stored in the file. For example, the instruction Add Record could be stored simply as the letter ‘A’. Once the optimum Change Log size has been reached, the Service Provider 2 digitally signs the Change Log 1.1 to provide data integrity, i.e. to reduce the possibility of unauthorized changes to the Change Log 1.1. The Service Provider 2 then creates a new Change Log 1.1 for any subsequent changes to the master catalog 1.

The Service Provider 2 has an index of Subscribers that use the specific catalog for which a Change Log 1.1 has been created. An email notification 5 is now created for each Subscriber 20 that the Change Log 1.1 impacts. The Subscriber's email address is stored in the Subscribers database 3, i.e. see Table 1 above.

Referring to Table 2 the email message contains pertinent information so that the Subscriber 20 can download and apply the Updates 11 that are contained in the Change Log 1.1.

TABLE 2

| Change Log Email Data | | Description |
|---|---|---|
| 1. | Service Provider Name | Name of the Service Provider |
| | | that maintains the Master catalog |
| 2. | Catalog Name | The name of the subscribed |
| | | catalog, directory, database, |
| | | etc. that has changed |
| 3. | Size of Change Log | The file size in number of bytes |
| | | that the changes encompass |
| 4. | Number of changes | Total number of changes, |
| | | i.e. count of records added, |
| | | deleted and modified |
| 5. | Encrypted login password | Password used to log onto |
| | | the Service Provider's Internet |
| | | Address to download |
| | | the relevant Change Log |
| 6. | Subscriber's User ID | User ID to log on to the Service |
| | | Provider's Internet Address. |
| | | This matches the User ID |
| | | in Table 1. This ID can be |
| | | encrypted as well. |
| 7. | Time Stamp of Change Log | The date and time that |
| | | the Change Log was generated |
| 8. | Service Provider Internet Address | The network address where |
| | | the Service Provider has the |
| | | Change Log available for |
| | | downloading, e.g. a URL such |
| | | as https:/updates.service- |
| | | provider.com |
| 9. | Digital Signature | The Service Provider's |
| | | digital signature |
| | | for the email body. |

Subscriber Updates

When the Subscriber 20 receives the email 5 that provides notification of the availability for a Change Log 1.1 to be downloaded, (i.e. Updates 11) a program resident on the Subscriber's computing device (i.e. the Update Program 10) executes the following steps:

Step 1: Verifies the Digital Signature of the email 5. This verification authenticates the sender, i.e. the Service Provider 2, as well as ensures that the contents of the email 5 have not been tampered with. Refer to the above section titled Cryptography for Verification, Integrity and Confidentiality for more details on how this is done using PKI.

Step 2: If the email 5 verification fails, the Subscriber 20 is notified not to trust the email and the email is marked for deletion, i.e. the catalog update procedure is aborted. The Update Program 10 sends a readable copy of the problematic email 5 to the Service Provider 2 to resolve the verification problem.

Step 3: If the email 5 verification is good, then the Update Program 10 notifies the Subscriber 20 that Updates 11 are available for her local Directory/Catalog 9 copy to be downloaded. The Update Program 10 sends a confirmation email to the Service Provider 2 that verification was successful, which is duly logged.

Step 4: The Update Program 10 then calculates the amount of disk space needed to implement the Updates 11. If insufficient space is available, the Subscriber 20 is prompted to free the calculated amount of disk space. The evolution of computer memory is making increasingly larger amounts of memory available in microchip form, hence the preferred embodiment's disk space could be replaced with chip memory, i.e. M-Systems' DiskOnChip device. For discussion purposes in the preferred embodiment, disk memory is synonymous with computer-chip memory.

Step 5: With the calculated amount of disk space available, the Update Program 10 requests permission from the Subscriber 20 to download the Change Log 1.1 available from the Service Provider 2. The file size and calculated time to download the Change Log 1.1 is displayed to the Subscriber 20.

Step 6: If the Subscriber 20 denies the Update Program 10 permission to download the Updates 11, the Update Program 10 prompts the Subscriber 20 when it may execute the download. The Update Program 10 then hibernates until the download time is reached. Upon reactivation the Subscriber's Update Program 10 logs onto the Internet 4 if necessary.

Step 7: Once the Update Program 10 receives permission from the Subscriber 20 to download the Updates 11, the Update Program 10 decrypts the Encrypted login password (refer to Table 2, entry 5) that was included in the update notification email 5. If the Service Provider 2 encrypted the Subscriber's User ID, this is also decrypted at this time.

Step 8: The Update Program 10 securely logs onto the Service Provider's Internet Address (e.g. using SSL), which was included in the verifiable update notification email 5 (refer to Table 2, entry 8). The Update Program 10 uses the Subscriber's User ID (refer to Table 2, entry 6) that was included in the update notification email 5, together with the decrypted login password to login securely to the Service Provider's Internet Address. As mentioned previously, the Subscriber's electronic device (i.e. remote electronic system) can access the Internet 4.

Step 9: The Update Program 10 passes the Catalog Name (refer to Table 2, entry 2) and Time Stamp of Change Log (refer to Table 2, entry 7) to the logon program running on the Service Provider's computer. The Service Provider logon program uses this information to retrieve the relevant Change Log 1.1 and allows the Subscriber's update program to download it, i.e. via Updates 11. The preferred embodiment does not download the Change Log 1.1 using an encrypted channel such as SSL. The reason for this is to save time on decrypting the transmitted data. If catalog confidentiality is required, then the Service Provider 2 encrypts the Change Log 1.1 using PKI. This obviously does not exclude the option of using an encrypted channel for downloading the Updates 11.

Step 10: Once the Updates 11 have been downloaded, the Update Program 10 verifies that the Updates 11 have retained their integrity by verifying the file's digital signature, i.e. message digest. The Service Provider 2 logs the state of the Updates 11 verification, which is communicated by the Update Program 10. The Subscriber's Update Program 10 then logs off from the Service Provider 2

Step 11: The Service Provider logon program logs the fact that the Subscriber 20 downloaded the relevant Change Log 1.1.

Step 12: The Subscriber's Update Program 10 converts the downloaded Updates 11 to a format that it can process. The Update Program 10 then calculates approximately the time it will take to update the Subscriber's local database, i.e. Directory/Catalog 9. The Update Program 10 displays this information to the Subscriber 20 before starting to apply the Updates 11 to the local database. The Subscriber 20 can request that the Update Program 10 delays updating the Directory/Catalog 9.

Step 13: The Subscriber's Update Program 10 applies the changes listed in the downloaded Change Log 1.1 to the local copy of the Subscriber's Directory/Catalog 9. In the preferred embodiment of the invention, it is possible for the Update Program 10 to make a backup copy of the Directory/Catalog 9 prior to applying the Updates 11. This depends upon whether or not sufficient disk space is available.

Step 14: If during the application of the Updates 11 to the Subscriber's Directory/Catalog 9, an error is encountered then the Update Program 10 logs the error, skips over the current record and continues to apply the Updates 11. The erroneous record is marked as problematic in the Subscribers' Directory/Catalog 9.

Step 15: When the Subscriber's Update Program 10 has completed applying the Updates 11 to the Directory/Catalog 9, it checks to see if it has logged any errors. If errors exit, then it emails the list of errors to the Service Provider 2 for action. The Service Provider 2 logs the fact that the Subscriber 20 has updated her Directory/Catalog 9 and logs any Update Program 10 encountered errors.

Step 16: The Subscriber's Update Program 10 then notifies the Subscriber 20 that the Directory/Catalog 9 has been updated. Any errors encountered are also displayed, as well as the fact that the Service Provider 2 has been notified.

Step 17: The Subscriber's Update Program 10 then hibernates until a new email 5 is received from the Service Provider 2.

It is a possible variation of the preferred embodiment to completely automate the Change Log 1.1 update process, without any manual intervention from the Subscriber 20.

What is claimed is:

1. A method of synchronizing directory information stored on a central computer system and a copy of said directory information stored on a second remote electronic system, the method comprising the steps of:
determining whether any changes have occurred with the said directory information stored on the said central computer system and storing said changes in a log file;
determining which second remote electronic system requires said directory changes;
connecting said central computer system to said second remote electronic system with a data communications link;
sending an electronic mail message from said central computer system to said remote electronic system, on said data communications link, with notification of the presence of said log file;
sending confidential information in said electronic mail message detailing how to retrieve said log file.

2. The method of claim 1 wherein said remote electronic system further comprising the steps of:
receiving said electronic mail notification and verifying that said electronic mail was sent by said central computer system;
receiving said electronic mail notification and verifying that said electronic mail was not modified after being sent by said central computer system;
determining a time to retrieve said log file from said central computer system using said confidential information in said electronic mail message.

3. The method of claim 2 further comprising the steps of:
accessing securely the said central computer system on said communications link, using said confidential information in said electronic mail notification;
retrieving said log file by means of said communications data link storing said log file on remote electronic system;
disconnecting from said central computer system on said data communications link;
updating said directory information on said remote electronic system using said retrieved log file;
notifying said central computer system that said remote electronic system updated its directory information using said log file and notifying said central computer system of any errors encountered during the update;
notifying user of said remote electronic system that changes have been applied to copy of directory information stored on said electronic system.

4. The method of claim 1 wherein said communications link is the Internet or a company's private computer network.

5. The method of claim 1 wherein said confidential information is encrypted so that only the said remote electronic system and said central computer system can decrypt the said confidential information.

6. The method of claim 3 wherein said secure accessing of said central computer system by said remote electronic system is by means of the Secure Sockets Layer technology.

7. A method of synchronizing catalog information stored on a central computer system and a copy of said catalog information stored on a second remote electronic system, the method comprising the steps of:
determining whether any changes have occurred with the said catalog information stored on the said central computer system and storing said changes in a log file;
determining which second remote electronic system requires said catalog changes;
connecting said central computer system to said second remote electronic system with a data communications link;
sending an electronic mail message from said central computer system to said remote electronic system, on said data communications link, with notification of the presence of said log file;
sending confidential information in said electronic mail message detailing how to retrieve said log file.

8. The method of claim 7 wherein said remote electronic system further comprising the steps of:
receiving said electronic mail notification and verifying that said electronic mail was sent by said central computer system;
receiving said electronic mail notification and verifying that said electronic mail was not modified after being sent by said central computer system;
determining a time to retrieve said log file from said central computer system using said confidential information in said electronic mail message.

9. The method of claim 8 further comprising the steps of:
accessing securely the said central computer system on said communications link, using said confidential information in said electronic mail notification;
retrieving said log file by means of said communications data link storing said log file on remote electronic system;
disconnecting from said central computer system on said data communications link;
updating said catalog information on said remote electronic system using said retrieved log file;
notifying said central computer system that said remote electronic system updated its catalog information using said log file and notifying said central computer system of any errors encountered during the update;
notifying user of said remote electronic system that changes have been applied to copy of catalog information stored on said electronic system.

10. The method of claim 7 wherein said communications link is the Internet or a company's private computer network.

11. The method of claim 7 wherein said confidential information is encrypted so that only the said remote electronic system and said central computer system can decrypt the said confidential information.

12. The method of claim 9 wherein said secure accessing of said central computer system by said remote electronic system is by means of the Secure Sockets Layer technology.
